(19) United States
(12) Patent Application Publication
(10) Pub. No.: US 2003/0126081 A1
(43) Pub. Date: Jul. 3, 2003

(54) Check processing method and apparatus, and a computer-readable recording medium storing a check processing control program

(76) Inventor: Hiroshi Ono, Suwa-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/293,570

(22) Filed: Nov. 13, 2002

(30) Foreign Application Priority Data
Nov. 16, 2001 (JP) 2001-352181

(51) Int. Cl. G06F 17/60

(52) U.S. Cl. 705/42

(57) ABSTRACT

After first confirming that a check was inserted with its back side facing up, a consent agreement and signature line are printed on the back of the check and the check is then ejected. After the customer signs on the signature line, the check is reinserted and it is again confirmed that the check has been inserted with its back facing up. The back of the check is then scanned and the captured image data is recorded. Handling and managing checks for which payment was processed electronically is thus more efficient.

### BACKGROUND OF THE INVENTION

1. Field of the Invention

The present invention relates to a method and an apparatus for processing checks when settling a payment by check, and to a computer-readable medium on which a control program for implementing the check processing method is stored.

2. Description of the Related Art

When a check is used to pay for a purchase in a store, the store receives the check from the customer and typically confirms the validity of the check. If the check is valid, the payment information is printed on the front of the check and endorsement information is printed on the back of the check as required, and the check is then submitted to the issuing bank or clearing house for payment. Based on the information included on the check, the clearinghouse transfers funds from the account of the payer (check issuer) to the account of the payee (check recipient) to complete payment. Conventional check-based payment transactions are thus completed by delivering the physical check from the store to the payment organization.

Electronic payment transaction processing using checks has also progressed in recent years. This involves reading the account number and other data written or printed on the check at a checkout terminal in a store, and transmitting this data electronically to a server in the payment organization for processing and payment. When checks are thus processed electronically, the check can be returned directly to the customer at the point of sale. It therefore becomes unnecessary for the store to collect the checks, and the task of handling and processing the checks is significantly reduced.

The store, however, is required to obtain the customer's permission to process the check payment transaction electronically. The store therefore asks the customer to sign an agreement in which the customer consents to electronic check processing, and is required to keep these signed agreements for a specified period of time as proof of consent. A copy of the signed agreement is also given to the customer when the processed check is returned.

While electronically processing check payment transactions thus solves the problem of handling the physical checks for the store, the customer must now keep track of two separate documents, i.e., the check and the agreement, which makes check handling more difficult for the customer.

In addition, the store consumes more paper as a result of printing the agreement multiple times for each transaction and must also store and manage the signed agreement received from each customer. The store is therefore unable to realize the benefits of a completely paperless transaction.

There is, therefore, significant room for improving the efficiency of such transactions.

### OBJECTS AND SUMMARY OF THE INVENTION

An object of the present invention is to solve these problems.

It is another object of this invention to enable efficient check management when check payment transactions are processed electronically.

To achieve these objects a method for processing a check payment transaction, according to one aspect of the present invention, is provided. The method comprises determining whether or not to electronically process the check payment transaction, which generally involves obtaining consent from the check writer to proceed with such processing, and printing on the back side of the check a consent agreement indicating such consent to process the check payment transaction electronically if and when electronic processing of the check payment transaction is affirmed.

To achieve these objects an apparatus for processing a check payment transaction, according to another aspect of this invention, comprises an input unit for determining whether or not to electronically process the check payment transaction, and a printer for printing on the back side of the check a consent agreement indicating consent to process the check payment transaction electronically if and when electronic processing of the check payment transaction is affirmed.

Such a check processing apparatus may be in communication with a host device and may performing the check processing operations in response to commands received from the host device. The host device may, but need not, be a separate component. The host device and check processing apparatus may be integrated.

In accordance with still another aspect of the invention, a computer-readable medium containing a program for executing a check payment transaction process is provided. The program comprises instructions for: determining whether or not to electronically process the check payment transaction, and issuing a command for printing on the back side of the check a consent agreement indicating consent to process the check payment transaction electronically when electronic processing of the check payment transaction is affirmed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an overview of a check processing system according to a preferred embodiment of the present invention;

FIG. 2 is a block diagram of a check processing system according to the present invention;

FIG. 3 is a schematic view of a typical check processed by a check processing apparatus;

FIG. 4 is a first flow chart showing the process run in accordance with a first embodiment of the invention;

FIG. 5 is a second flow chart showing the process run in accordance with a first embodiment of the invention;

FIG. 6 is a third flow chart showing the process run in accordance with a first embodiment of the invention;

FIG. 7 is a fourth flow chart showing the process run in accordance with a first embodiment of the invention;

FIG. 8 describes the principle for determining the threshold value in the threshold value determination process shown in the flow chart in FIG. 4, and is an exemplary graph of the frequency distribution of gray levels in the pixels of the check image;

FIG. 9 is a flow chart showing an outline of the threshold value determination process run by the CPU of the check processing apparatus;

FIG. 10 shows the parts of the check from which images are captured by pre-scanning;

FIG. 11 is a flow chart showing the details of the gray level frequency distribution compiling process;

FIG. 12 is a flow chart showing the detailed content of a process for determining parameters PMin and PMax;

FIG. 13 shows an example of the consent agreement printed on the back of a check; and

FIG. 14 is a simplified side view of the inside of the check processing apparatus.

### DESCRIPTION OF THE PREFERRED EMBODIMENTS

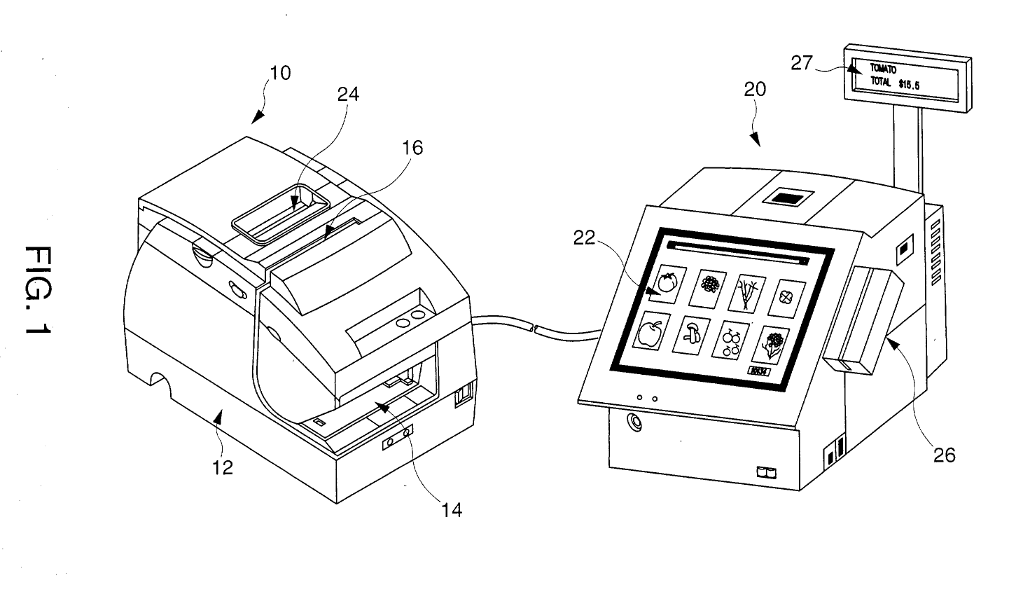

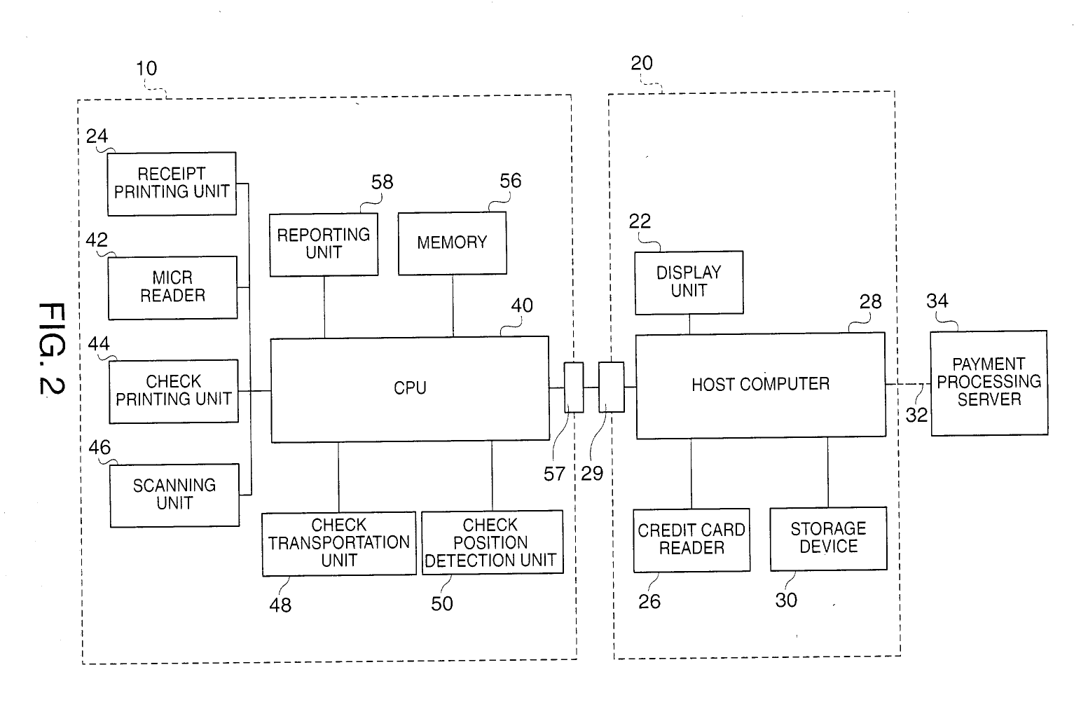

FIG. 1 is an overview and FIG. 2 is a block diagram of a check processing system according to a first embodiment of the present invention. As will be understood from these figures, a check processing system according to this first embodiment of the invention includes a check processing unit 10 and a cash register 20 installed at the checkout counter of a store, for example. The check processing unit 10 and cash register 20 are connected so that they can communicate with each other.

As shown in FIG. 1, the check processing unit 10 has a cover 12 that is typically made of plastic. An insertion opening 14 for inserting a check is disposed at the front of the cover 12, and an exit opening 16 from which the check is ejected is disposed in the top of the cover 12. A receipt printer or printing unit 24 is also provided in the top back part of the check processing unit 10.

The cash register 20 has a touch-panel display unit 22, a credit card reader 26, and a customer display 27.

As shown in FIG. 2, the check processing unit 10 has a central processing unit (CPU) 40. The cash register 20 has a host computer 28 and a storage device 30. The CPU 40 of the check processing unit 10 and the host computer 28 of the cash register 20 communicate with each other by means of a wireless or wired connection through interfaces 57 and 29 to exchange data.

The display unit 22, credit card reader 26, and storage device 30 of the cash register 20 are connected to the host computer 28. The host computer 28 is in turn connected through communication line 32 to the payment processing server 34 of a payment organization.

It should be noted that the payment organization could be a check clearing house (an organization that processes payments through banks or other financial organizations on behalf of stores, for example) or it could be a bank or other financial organization. The payment organization performs a validation function for determining whether a check is valid based on the account number, for example, of the payer, and a payment function for effecting a transfer of funds based on the check. The clearing house may be authorized only to determine check validity and thus not have the ability to process payments. In this case inquiries regarding check validity are sent to the clearing house while payment instructions are sent to the financial institution (or a clearing house with a payment processing capability). The present embodiment is described using by way of example a payment organization having both check validation and payment processing functions.

As shown in FIG. 2, the check processing unit 10 also has connected to the CPU 40 a MICR reader 42, a check printer or printing unit 44, a scanner or scanning unit 46, a check transportation unit 48, a check position detection unit 50, memory 56 such as ROM or RAM, and an interface 57.

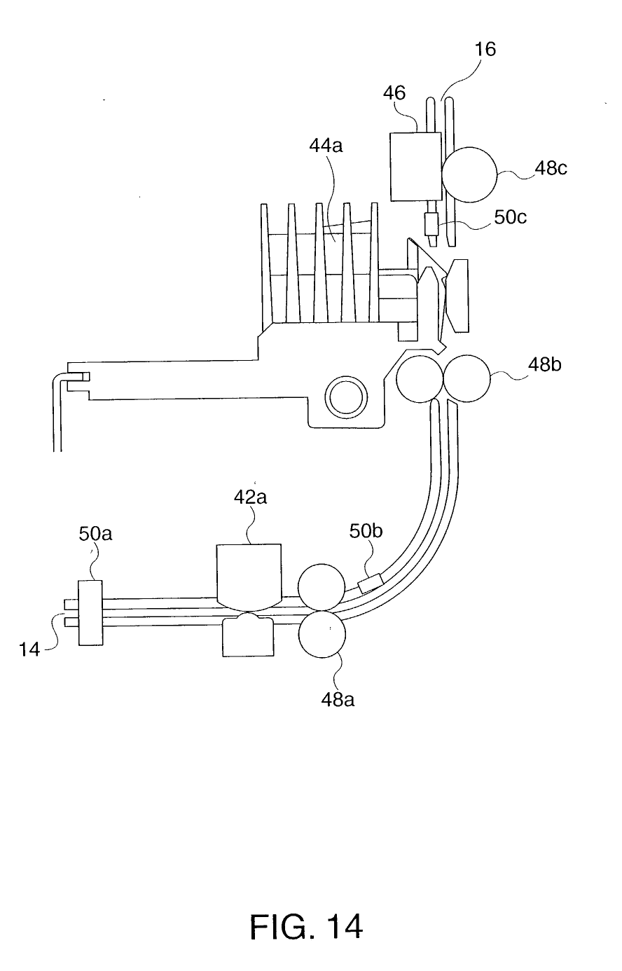

FIG. 14 is a simplified side view of the inside of the check processing unit 10 in this embodiment of the invention. As shown in FIG. 14 a check transportation path 15 is formed inside the check processing unit 10 between the insertion opening 14 and the exit opening 16. The insertion opening 14 side of the check transportation path 15 is horizontally oriented and the exit opening 16 side is vertically oriented so that when seen from the side check transportation path 15 curves in an L shape. Disposed along the check transportation path 15 in order from the insertion opening 14 side are detector 50a, MICR head (magnetic head) 42a, feed rollers 48a, detector 50b, feed rollers 48b, print head 44a, detector 50c, scanning unit 46, and a feed roller 48c the scanning unit 46.

The MICR reader 42 has a magnetic ink character recognition (MICR) function for reading magnetic ink characters printed on the front side of the check by means of a MICR head 42a and a controller for analyzing the magnetic head output signal to recognize magnetic ink characters. As further described below, data read by the MICR reader 42 is sent through interface 57 to the host computer 28 in response to a command from the CPU 40. Based on the data read by the MICR reader 42, the host computer 28 sends a check validation request to the payment processing server 34.

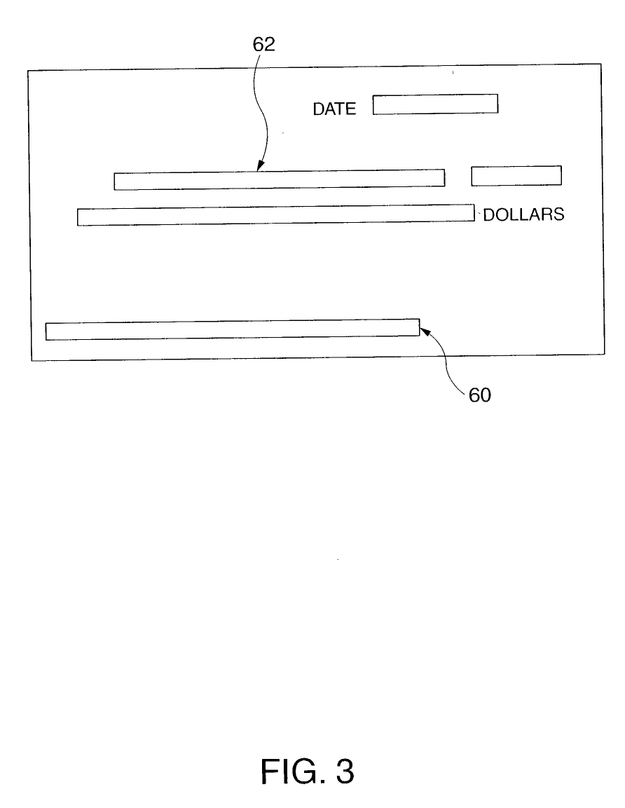

FIG. 3 is a plan view showing the front side of a typical check processed by a check processing unit 10 according to the present embodiment of the invention. Magnetic ink characters are recorded in the MICR recording area 60 on the front side of the check as shown in FIG. 3, and include the payer account number of the check. It should be noted that this account number is a number uniquely identifying a specific account, and is an individual account number including the bank code, branch code, or other routing information.

The check printing unit 44 has a dot impact print head or other suitable print head. The check printing unit 44 prints the check front items including the payee, date, payment amount, and any other payment information to the front side of the check as instructed by the CPU 40. It also prints a consent agreement permitting the store to electronically process the check and a signature line, in addition to any endorsement information, on the back side of the check as instructed by the CPU 40. The check face items are printed to the face item printing area 62 shown in FIG. 3.

The receipt printing unit 24 has a thermal print head or other appropriate type of print head for printing a sales receipt, coupons, and/or other information to roll paper pulled out from the roll paper compartment, and then cuts the printed roll paper with an automatic paper cutter (not shown in the figure) as instructed by the CPU 40.

The scanning unit 46 has a contact image sensor or other appropriate type of image sensor, scans the check face as instructed by the CPU 40, and stores the captured image temporarily to memory 56 (RAM). In this embodiment of the invention the pixels of the image data output by the check position detection unit 50 are 8-bits deep, producing a 256-level (0 to 255) gray scale image.

It will be noted that this embodiment of the invention runs processes for reading magnetic ink characters with the MICR reader 42, printing with the check printing unit 44, and scanning with the scanning unit 46 using the top of the check inserted to the insertion opening 14 (that is, the side facing the MICR head 42a, print head 44a, and scanning unit 46 disposed to the check transportation path 15 shown in FIG. 14), and to accomplish these operations the check is assumed below to be inserted to the insertion opening 14 with the side containing the magnetic ink character side facing up. These positions can be reversed, however.

The check transportation unit 48 transports the check along the transportation path 15, and includes multiple sets of transportation rollers 48a to 48c and motors and parts to drive these rollers.

The check position detection unit 50 detects the location of the check in the transportation path 15, and supplies signals to the CPU 40 indicating when the check reaches specific positions, that is, a position indicating the check has been inserted a specific distance from the insertion opening 14, the starting positions for printing the front side of the check and the consent agreement by the check printing unit 44, the reading start position of the MICR reader 42, the scanning start position and the pre-scanning start position of the scanning unit 46, and when the check has been ejected from the exit opening 16. As shown in FIG. 14, there are three detectors 50a to 50c along the check transportation path 15 in this embodiment of the invention.

The reporting unit 58 consists of LEDs, an LCD or other type of display panel, a buzzer, or other means for visually or audibly reporting the current printer status to the user.

The process run in this embodiment of the invention is described next.

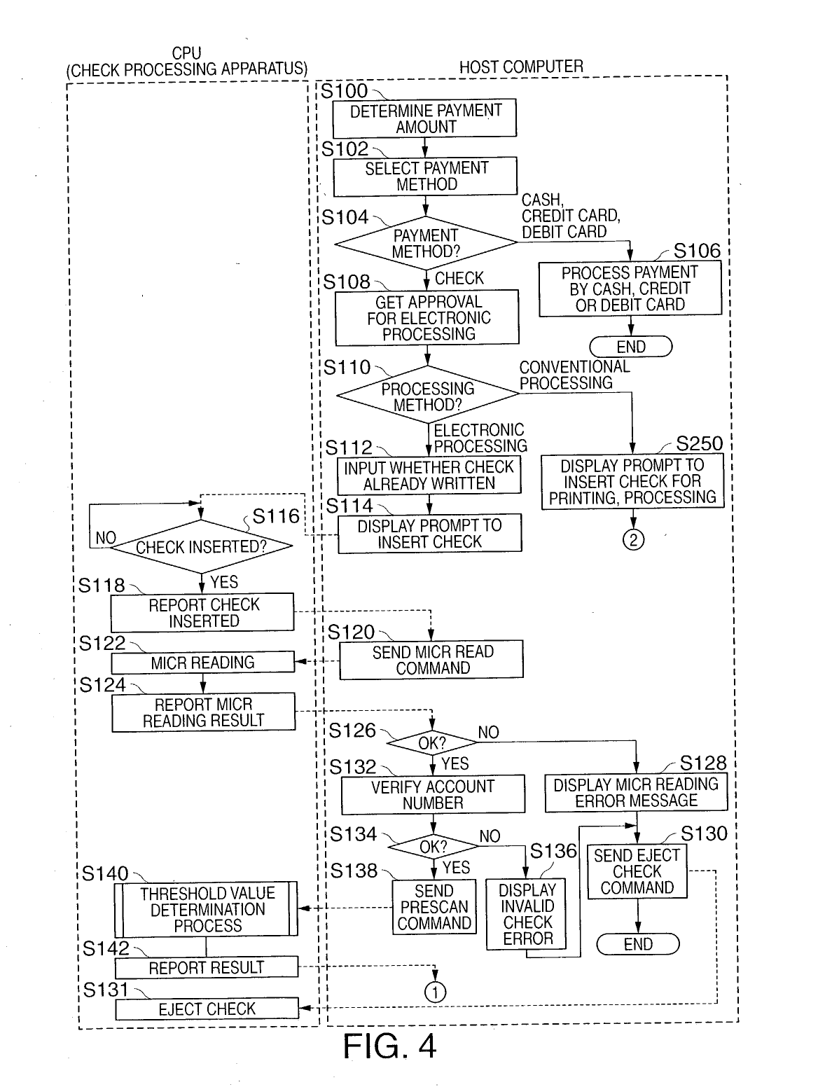

FIG. 4 to FIG. 7 are flow charts showing the overall flow of the check processing operation run by this embodiment of the invention. The process shown in FIG. 4 to FIG. 7 is executed by the CPU 40 executing firmware stored in memory 56 (ROM) and host computer 28 reading and executing a program stored in the storage part of storage device 30.

As shown in FIG. 4, at the end of the customer checkout process completed at the cash register, the payment amount for that customer is calculated by the host computer 28 (S100). A selection screen is then presented on the display unit 22 for selecting the payment method, i.e., cash, credit card, debit card, or check (S102). The payment method selected from this screen is then detected (S104). If cash or credit or debit card is selected, payment is processed using cash or the selected card (S106) and the payment process ends.

However, if payment by check is selected, a confirmation screen for confirming whether electronic processing of the check payment transaction is acceptable is presented on the display unit 22 (S108). If the checkout clerk obtains customer consent to electronically process the check payment transaction, the clerk presses a “confirm” button on the confirmation screen. If approval is not received, a “conventional processing” button is pressed.

The host computer 28 then determines which button was pressed on the confirmation screen (S110). If the “confirm” button was pressed a screen for indicating whether or not the check was already written, i.e., whether the check face items have been filled in, is presented (S112). This indication of whether the check has been written or not is used later to determine whether the check processing unit 10 needs to print the face items. The process run when “conventional processing” is selected is further below described.

Once the operator indicates whether the check has been written, a message prompting the operator to insert the check is displayed (S114). The operator then inserts the check received from the customer to the insertion opening 14 of the check processing unit 10 and the CPU 40 of the check processing unit 10 determines if the check has been inserted based on the detection signal from the check position detection unit 50 (S116). When check insertion is detected the CPU 40 outputs a signal to that effect to the host computer 28 (S118). This signal causes the host computer 28 to send a command to the CPU 40 for reading the magnetic ink characters on the check (S120).

This command causes the CPU 40 to drive the check transportation unit 48 to advance the check to the MICR reading position of the MICR reader 42, and then drive the MICR reader 42 to read the magnetic ink characters (S122). If the magnetic ink characters are successfully read, the captured account number and other information is sent as the reading result to the host computer 28; if reading the magnetic ink characters fails, a corresponding error signal is sent to the host computer 28 (S124).

Based on the result sent from the CPU 40, the host computer 28 determines whether MICR reading was successful (S126). If reading failed, a message telling the operator that MICR reading was unsuccessful is displayed (S128), a signal is sent to the CPU 40 to eject the check (S130), and processing ends. If the CPU 40 receives this check ejection signal it drives the check transportation unit 48 to eject the check from exit opening 16 (S131). Check processing is thus prevented from continuing if an invalid check without magnetic ink characters (or a piece of paper other than a check) is inserted, or if the check is inserted backwards, for example.

If the magnetic ink characters were read, the host computer 28 asks the payment processing server 34 if the account number in the captured MICR data is correct (that is, if an account of that account number exists) (S132, S134). If the account number is incorrect, a message that the check cannot be processed is displayed (S136), a check ejection command is sent to the CPU 40 (S130 above), and processing ends. If the account number is correct, a start pre-scanning command is sent to the CPU 40 (S138).

When the CPU 40 receives a start pre-scanning command it pre-scans the check and runs a threshold value determination process (S140) until a threshold value for binarizing the image data is determined.

FIG. 8 is used to describe the principle used to set the threshold value in the threshold value determination process shown as step S140 in FIG. 4, and shows the frequency distribution of gray levels in the pixels of the check image. The threshold value determination process of this embodiment shown in step S140 (FIG. 4) separates the gray level frequency distribution into peak P1 and peak P2 levels, and sets the median between PMin at the upper limit of the dark peak P1 values and PMax at the lower limit of the bright peak P2 values as threshold value TH. Parts of the image with a low gray level value (i.e., dark colored parts) corresponding to printing on the check and handwritten letters are in the peak P1 range, and parts with a high gray level value (i.e., light colors) corresponding to the check background are in the peak P2 range.

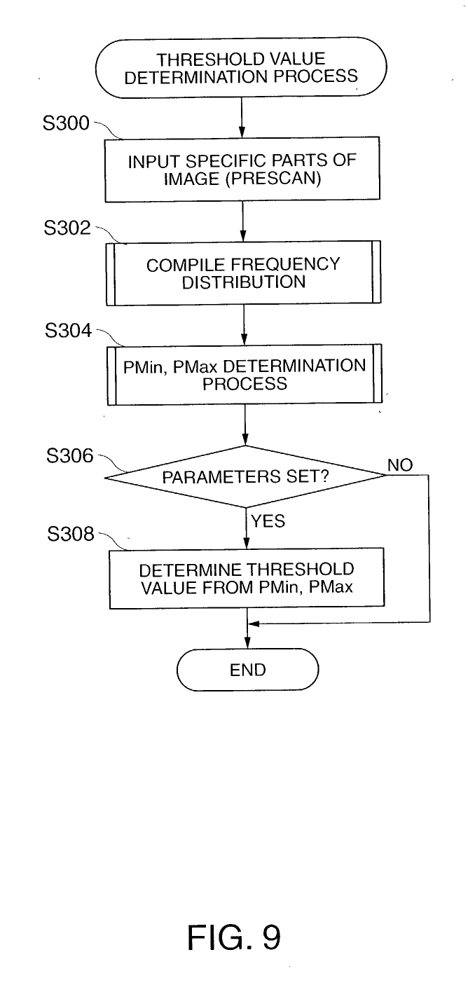

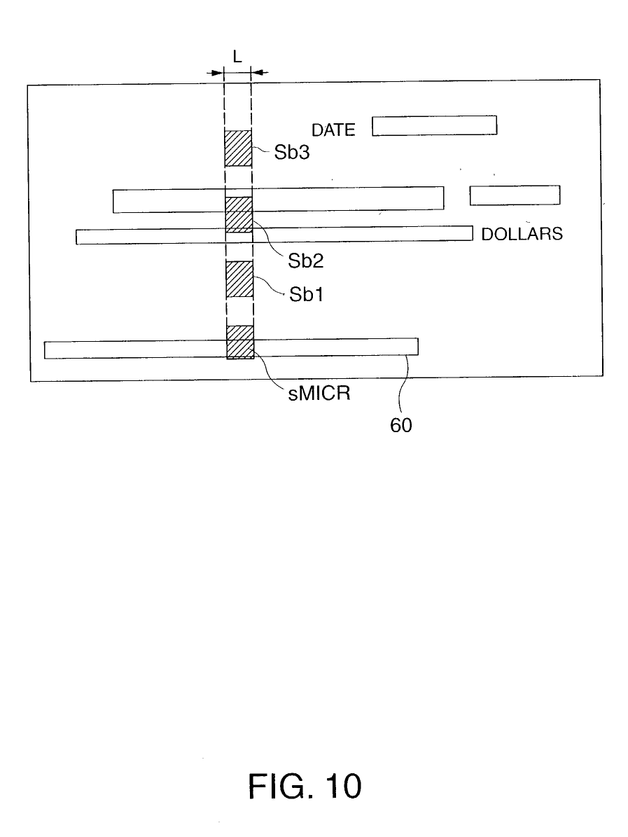

FIG. 9 is a flow chart showing the outline of the threshold value determination process run by the CPU 40 based on this principle. The first step is to capture an image of the check (image data) by pre-scanning specific parts of the check (S200). FIG. 10 shows the parts of the check captured by this pre-scanning operation. As shown in FIG. 10 pre-scanning captures images of the area SMICR overlapping the MICR recording area 60 where magnetic ink characters are recorded (below referred to as MICR part SMICR), and areas Sb1 to Sb3 where magnetic ink characters are not recorded (the non-MICR parts). In this embodiment of the invention MICR part SMICR and non-MICR parts Sb1 to Sb3 are in a row widthwise across the check. When the check is scanned an image is read by the scanning unit 46 while transporting the check lengthwise. By thus selecting MICR part SMICR and non-MICR parts Sb1 to Sb3 pre-scanning can be completed by advancing the check the length L of these parts as shown in FIG. 10, and the time required for pre-scanning can thus be shortened.

Pre-scanning shall not, however, be limited to these areas, and the pre-scanning areas can be desirably selected in order to determine the most appropriate threshold values. For example, two or more MICR areas could be scanned instead of just one, and 1, 2, 4, or other number of non-MICR parts other than 3 could be scanned. The location and size of the pre-scanning areas can also be otherwise selected.

When pre-scanning is completed a frequency distribution representing the frequency of gray levels in the pre-scanned image data is compiled (S302).

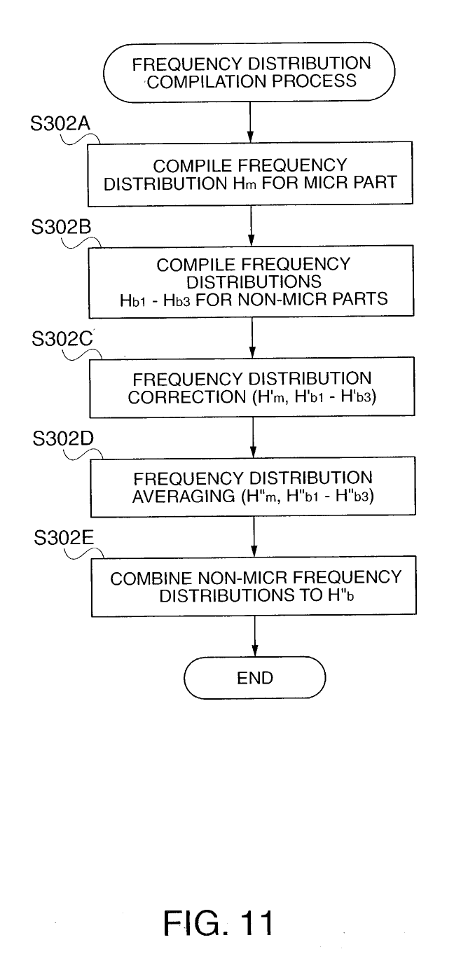

FIG. 11 is a flow chart showing the frequency distribution compiling process in detail. As shown in the figure the first step is to determine frequency distribution Hₘ(g) from image data in the MICR part SMICR (S302A) where g is a value from 0 to 255 in this embodiment denoting the gray level of each pixel with a higher value indicating a brighter (whiter) gray level. The MICR part SMICR is the part of the check containing particularly important information and is therefore weighted by, for example, doubling the value of each frequency when compiling the frequency distribution Hₘ(g), that is, Hₘ(g)=2·Hₘ(g) in MICR part SMICR.

Frequency distributions Hₘ(g), H_{b1}(g), H_{b2}(g), and H_{b3}(g) are then determined from the image data for the non-MICR parts Sb1 to Sb3 (S302B).

Frequency distributions Hₘ(g), H_{b1}(g), H_{b2}(g), and H_{b3}(g) are then corrected as follows to obtain H′ₘ(g), H′_{b1}(g), H′_{b2}(g), and H′_{b3}(g), respectively (S302C).

If g≦BGth,

H′ₘ(g)=Hₘ(g)

H′_{b1}(g)=H′_{b1}(g) (i=1, 2, 3)

If g≧BGth,

H′ₘ(g)=0

H′_{b1}(g)=0 (i=1, 2, 3)

where BGth is set to the minimum gray level, such as 254, detected when imaging the check background where a scanning object is not before the photo detector of the scanner 46. The above correction therefore clears to zero the frequency of image areas where an image of the back of the check is also included in the scanned image so that the frequency distribution can be correctly determined for only the desired parts of the check.

The average of each frequency distribution is then determined by calculating the average of a total (2·K+1) frequencies, that is, the frequency of gray level g and the frequency of the 2·K gray levels adjacent thereto (the K gray levels higher and the K gray levels lower than gray level g), for the frequency of each gray level g in the corrected frequency distributions H′ₘ(g), H′_{b1}(g), H′_{b2}(g), and H′_{b3}(g) (S302D).

More specifically, H″ₘ(g) is calculated for MICR part SMICR using equation (1) set forth below:

$${H}_{m}^{″} = \{ \begin{matrix}{\sum }_{k = - K}^{K} {H}_{m}^{′} ( g + k ) / ( 2 \cdot K + 1 ) & K \leq g \leq 255 - K \\ 0 & g < K , g > 255 - K\end{matrix}$$

and H″_{b1}(g), H″_{b2}(g), and H″_{b3}(g) are calculated for non-MICR parts Sb1 to Sb3 using equation (2) below:

$${H}_{bi}^{″} = \{ \begin{matrix}{\sum }_{k = - K}^{K} {H}_{bi}^{′} ( g + k ) / ( 2 \cdot K + 1 ) & K \leq g \leq 255 - K \\ 0 & g < K , g > 255 - K\end{matrix}$$

i=1, 2, 3

where K is a desirable value such as 4.

This averaging process removes noise components from the frequency distribution, and enables features in different parts of the image to be correctly expressed by the frequency distribution.

The unified frequency distribution H″_{b}(g) is calculated for the non-MICR parts by obtaining the sum of frequency distributions H″ₘ(g), H″_{b1}(g), H″_{b2}(g), and H″_{b3}(g) for the non-MICR parts using the following equation (S302E):

H″_{b}(g)=H″_{b1}(g)+H″_{b2}(g)+H″_{b3}(g)

(g=0 to 255)

This completes the frequency distribution calculation process.

A process for determining parameters PMin and PMax for calculating the threshold value from the resulting frequency distributions H″ₘ(g) and H″_{b}(g) is run next (S304, FIG. 8).

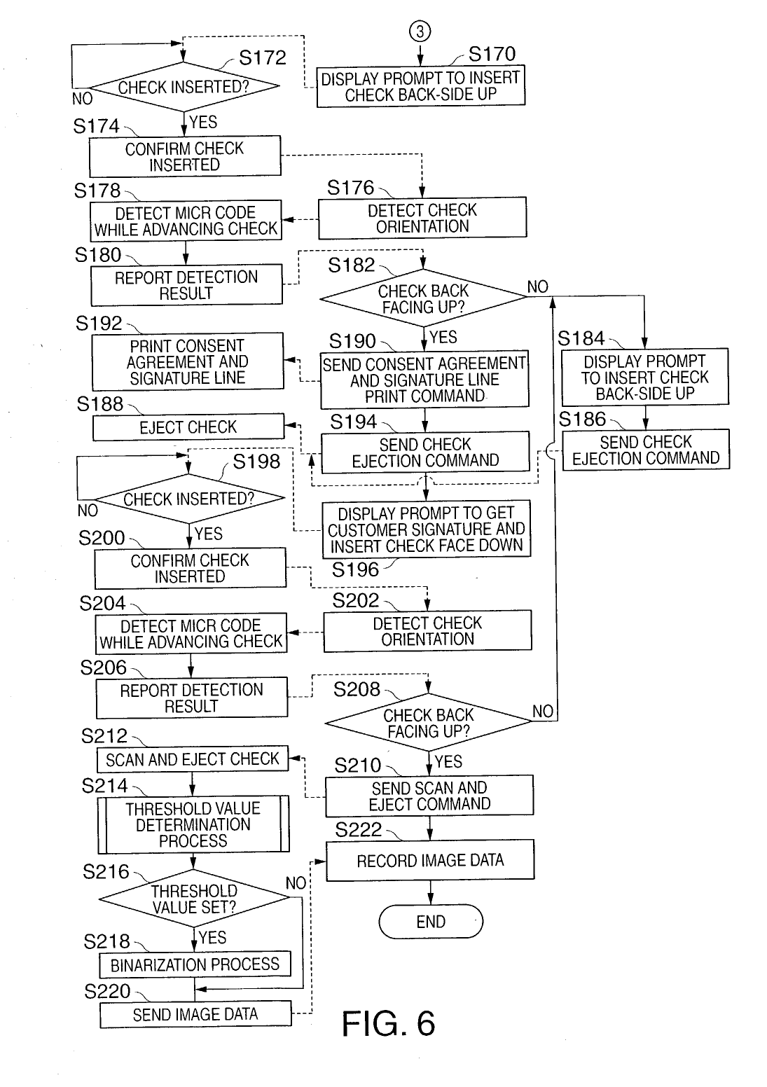

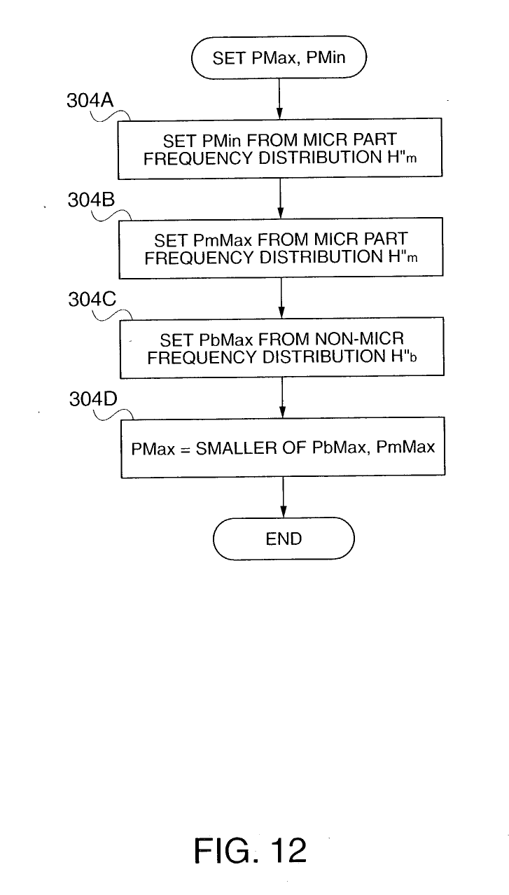

FIG. 12 is a flow chart showing the details of the process for determining parameters PMin and PMax. As shown in FIG. 12 the first step in this process is to determine parameter PMin from the frequency distribution H″ₘ(g) for MICR part SMICR (S304A). This parameter PMin is obtained as the value where the sum of g=0 to PMin is a specific value R (e.g., 0.1) (see the left side of FIG. 6) for relative frequency r(g) (the ratio to the total frequency) of MICR part SMICR frequency distribution H″ₘ(g). That is, PMin is

$$r ( g ) = {H}^{″} ( g ) / {\sum }_{k = 0}^{255} {H}_{m}^{″} ( k ) \qquad equation ( 3 )$$

and g is obtained as the highest value where

$${\sum }_{k = 0}^{g} r ( k ) < R \qquad equation ( 4 )$$

is true.

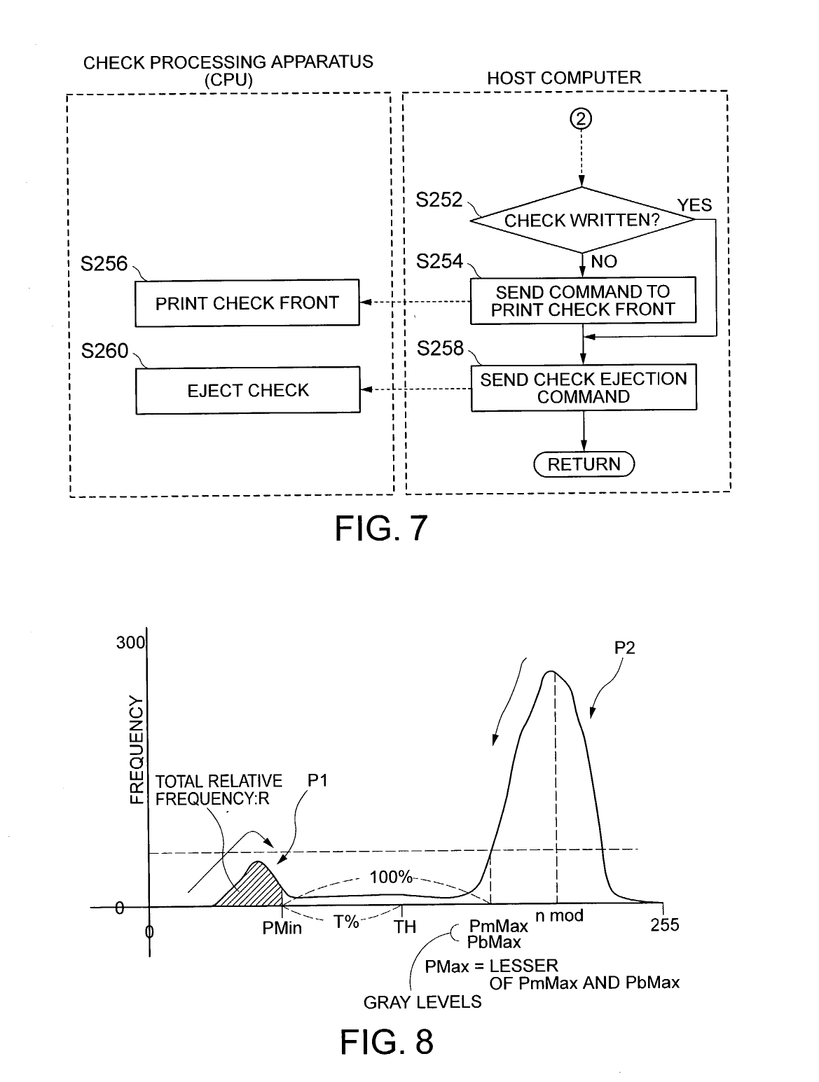

Parameter PMax is then obtained from the frequency distribution H″ₘ(g) for MICR part SMICR (S304B). More specifically, using the value of g with the highest frequency in frequency distribution H″ₘ(g) as maximum frequency nmod, the value of g is decreased one at a time from nmod to find the first value of g in frequency distribution H″ₘ(g)) that is less than a specific value M (such as 30). This value is then set to PmMax (see the right side of FIG. 7).

Parameter PbMax is then obtained from the frequency distribution H_{b}(g) for the non-MICR parts (S304C). This parameter PbMax is obtained similarly to PmMax above. That is, the value nmod for the peak g in frequency distribution H″_{b}(g) is detected, and nmod is decremented one at a time to find the first value g in frequency distribution H″_{b}(g) where the value of H″_{b}(g) is less than a specific value M. This value is then set to PbMax.

PmMax for the MICR part SMICR and PbMax for the non-MICR parts are then compared and the smaller value is used as PMax (S304D).

After parameters PMin and PMax are thus obtained it is determined whether a threshold value for binarizing the image can be determined (S306, FIG. 7). More specifically, a threshold value cannot be determined if PMax is 0, but otherwise a threshold value can be determined. If PMax is 0 then there is no frequency on the down side of the peak frequency (that is, the side on which the gray level decreases) less than constant M in either frequency distribution H″ₘ(g) for the MICR part SMICR or frequency distribution H″_{b}(g) for the non-MICR parts Sb. This occurs in the background areas where text is not written on the check and peak P2 for light colors is not clearly evident in the frequency distribution, and a threshold value therefore cannot be determined. In other words, information contained in the original image data cannot be reproduced in the binarized image.

If the threshold value can be determined, threshold value TH is calculated using PMin and PMax (S308, FIG. 9). More specifically, threshold value TH is the value between PMin and PMax offset T % (e.g., 58%) from PMin, i.e.,

TH=PMin+(PMin−PMax)×T/100.

However, if PMin≧PMax (that is, peak P1 on the dark side and peak P2 on the bright side overlap), then threshold value TH=PMin.

When CPU 40 completes this threshold value determination process it sends a result indicating whether the threshold value was determined to the host computer 28 (S142, FIG. 4)

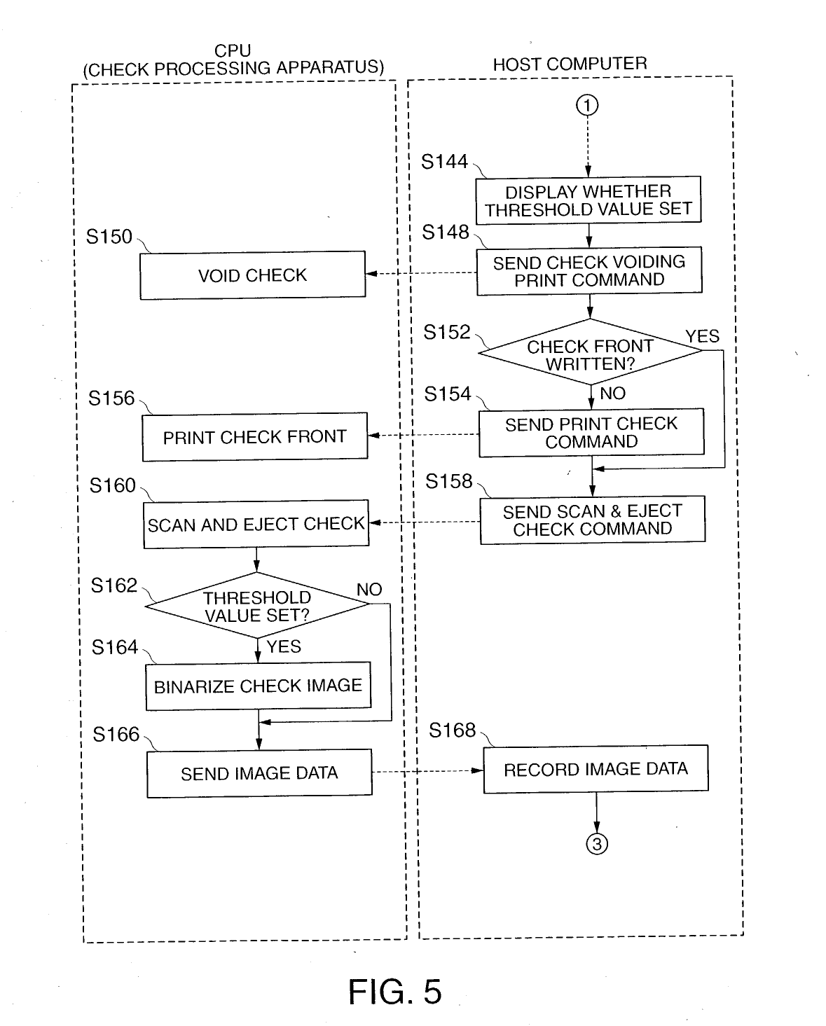

If based on the result returned from the CPU 40 the host computer 28 knows that the threshold value could not be set, it displays an appropriate message (such as to indicate that the image data will not be binarized for storage) (S144, FIG. 5). Displaying such a message could be omitted, however, in which case the CPU 40 can simply send a signal (in step S142) to the host computer 28 indicating that the threshold value determination process ended.

When the host computer 28 receives the above process results from the CPU 40 it sends a check voiding printing command to the CPU 40 (S148). The CPU 46 then drives the check transportation unit 48 to advance the check to the printing start position for check voiding and voids the check by printing VOID or similar phrasing to the check face by means of check printing unit 44 (S150). If capturing the check void printing in the image data is undesirable, check void printing can be run as a separate process.

When the host computer 28 receives a signal from the CPU 40 that check void printing is completed it determines (S152) whether to print the front side of the check based on the result returned from step S112 indicating whether the check was already written. If the check has not been written the host computer 28 determines that the front side of the check must be printed and sends a command to the CPU 40 for printing the payee, date, amount, and other necessary items to the check face (S154). The CPU 40 then drives the check transportation unit 48 to carry the check to the check face printing start position, and then drives the check printing unit 44 to write the check (S156).

When the host computer 28 receives a signal from the CPU 40 that printing the check face is completed it advances to step S158. If it determines in step S152 that the check was already written, the host computer 28 knows it is unnecessary to print the check face, and advances to step S158 without sending the print check command.

It should be noted that of the payee, amount, and date items printed to the check face the payee is the name of the store where the system is used and is preset for each system, the amount is the payment amount determined in step S100 above, and the date is obtained from the system clock. It is therefore not necessary to input this information each time a check is printed.

The host computer 28 then sends an image capture command to the CPU 40 to scan the check (S158). When the CPU 40 receives this command it drives the scanning unit 46 to scan the check while driving the check transportation unit 48 to carry the check passed the scanner and eject the scanned check from the exit opening 16 (S160). It should be noted that the image data captured by scanning in step S160 could include the entire face of the check or only the parts required to capture specific information from the check, such as the check number, account number, payer signature, and amount.

The CPU 40 then determines if the threshold value was set in the threshold value determination process in step S140 (S162). If the threshold value was able to be set it is known that the information items required to identify the check can be reproduced if the image data is binarized. The binary image data can therefore be used as proof of a transaction. The image data is therefore binarized using the threshold value TH (S164), and the binary image data is sent to the host computer 28 (S166).

If the threshold value could not be determined the information items required to identify the check cannot be reproduced if the image data is binarized. The scanned 256-level image data is therefore sent directly to the host computer 28 (S166) without being binarized.

The host computer 28 then stores the image data sent from the CPU 40 in storage device 30 together with the account number of the check, amount, and other payment data (S168).

The host computer 28 then displays a prompt on the display unit 22 telling the operator to insert the check with the back side up (step S170 in FIG. 6). The operator then inserts the check ejected in step S160 to the insertion opening 14 of check processing unit 10 so that the back side of the check is facing up. The CPU 40 of check processing unit 10 then detects whether the check has been inserted based on the detection signal output from the check position detection unit 50 (step S172), and sends a confirmation signal to the host computer 28 when the check is inserted (step S174).

The host computer 28 then returns a command to the CPU 40 to confirm whether the front side or the back side of the check is facing up (step S176). The CPU 40 then detects whether magnetic ink characters are detected by the MICR reader 42 as the check is transported by the check transportation unit 48. If magnetic ink characters are not detected by the time the check is transported to a specific position (i.e., the position at which magnetic ink characters should be detected if the check is inserted face up), the check is known to be inserted with the back side facing up. On the other hand, if magnetic ink characters are detected by the time the check reaches this specific position, the check is known to be inserted face up (step S178). The CPU 40 then sends the result of this check orientation detection to the host computer 28 (step S180).

The host computer 28 then evaluates the result returned from the CPU 40 (step S182). If the check was inserted face up (back down) a message is displayed as in step S170 telling the operator to insert the check with the back side facing up (step S184), and the host computer 28 tells the CPU 40 to eject the check (step S186). The CPU 40 thus ejects the check from the exit opening 16 by means of check transportation unit 48 (step S188). When the CPU 40 then sends a signal to the host computer 28 indicating that the check has been re-inserted to the insertion opening 14 (S172, S174), the host computer 28 repeats the steps from step S176.

If the host computer 28 detects in step S182 that the check was inserted face down, the host computer 28 sends a command to the CPU 40 for printing the consent agreement and signature line (step S190). The CPU 40 thus drives the check transportation unit 48 to advance the check to the consent agreement and signature line printing start position, and the consent agreement and signature line are then printed by means of the check printing unit 44 (step S192).

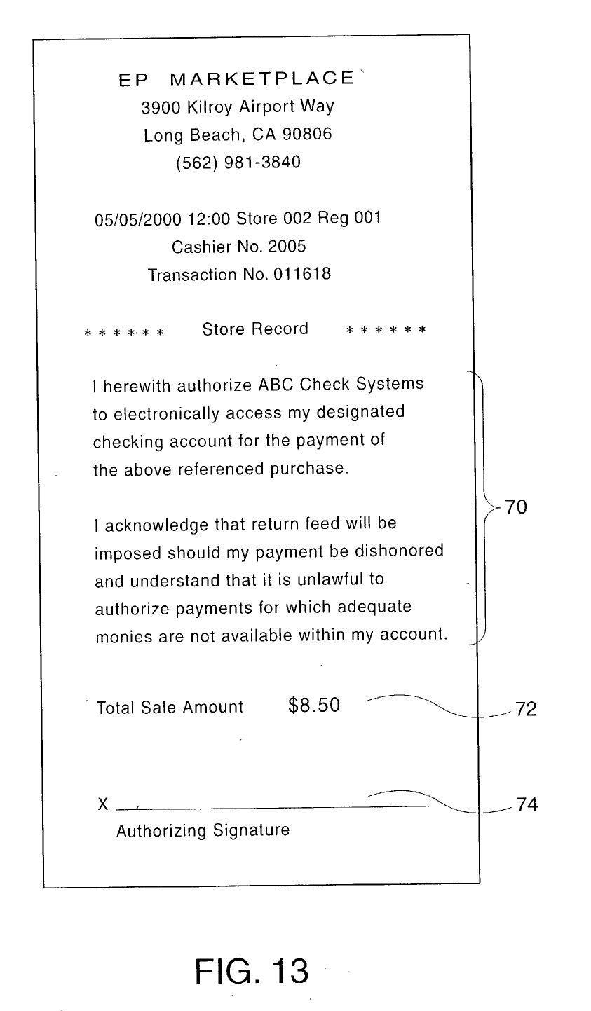

FIG. 13 shows an example of the consent agreement and signature line printed to the back side of the check. As shown in FIG. 13 a consent agreement 70 allowing the check to be paid electronically, the payment amount 72, and a signature line 74 are printed to the back side of the check.

This embodiment of the invention determines that the check was inserted with the back side facing up and therefore ejects the check if magnetic ink characters are detected by the time the check is transported to a specific position. However, if the position where printing the consent agreement and signature line starts is farther from the insertion opening 14 than this specific position, the check could be transported to the consent agreement and signature line printing start position while sensing magnetic ink characters. In this case if magnetic ink characters are detected before the check reaches this printing start position, the check is known to have been inserted face up and is therefore ejected accordingly.

When the host computer 28 is notified by the CPU 40 that printing the consent agreement and signature line is completed, it sends a command to the CPU 40 to eject the check (step S194). The CPU 40 then drives the check transportation unit 48 to eject the check from the exit opening 16 (step S188). When the CPU 40 reports that the check has been ejected, the host computer 28 displays a message on the display unit 22 telling the operator to have the customer sign the consent agreement and then re-insert the check with the back side facing up (step S196).

The operator then presents the check with the printed consent agreement and signature line to the customer for the customer to sign. Once the consent agreement is signed the operator again inserts the check with the back side (that is, the side containing the consent agreement and signature line) facing up to the insertion opening 14.

CPU 40 then detects if the check has been inserted based on the detection signal from the check position detection unit 50 (step S198), and when the check is detected applies a corresponding signal to the host computer 28 (step S200). The orientation of the check is then detected (step S202 to S208) as in steps S176 to S182 above. If the check has not been inserted face down, a message prompting the user to insert the check with the back side facing up is again presented (step S184 to S188), and the check is ejected.

If the check was inserted with the consent agreement side facing up, host computer 28 instructs the CPU 40 to scan the check (step S210). CPU 40 thus drives the scanning unit 46 to scan the check while the check transportation unit 48 carries the check passed the scanning unit 46 (step S212). It should be noted that at least the part of the check containing the consent agreement and signature line are scanned. Based on the scanned image data the CPU 40 runs the same threshold value determination process described in step S140 above (step S214).

Whether a threshold value was set is then determined (step S216). If it was, a binarization process is run using the set threshold value (step S218), and the binary image data is sent to the host computer 28 (step S220). If a threshold value could not be set, the scanned gray scale image is sent directly to the host computer 28 without binarization (step S220). The host computer 28 stores the image data received from the CPU 40 correlated to the image data on the front side of the check and payment data stored in step S168 to the storage device 30 (step S222).

If in step S110 (FIG. 4) the customer's consent to electronic processing is not received, host computer 28 displays a message on the display unit 22 prompting the operator to insert the check for printing the front side (step S250), and then continues operation from step S252 in FIG. 7.

More specifically, as in steps S152 and S154 in FIG. 5, whether the front side of the check has been written is determined (step S252). If the front side has not been written the CPU 40 is instructed to print the check front items (step S254), and the CPU 40 therefore runs the check front printing process (step S256). The host computer 28 then sends a check ejection command to the CPU 40 (step S258), and the CPU 40 therefore ejects the check from exit opening 16 (step S260). After the check is ejected only the detailed receipt printed by the receipt printing unit 24 is handed to the customer. The store keeps the check for conventional, i.e., not electronic, check payment processing.

At a specific time each day, such as during the night, the host computer 28 sends a payment processing request to the payment processing server 34 based on the payment data stored in the storage device 30. In response to this payment request the payment processing server 34 then runs a process for transferring funds from the account identified by the account number of each check to the account specified by the store, thus completing payment by check.

A check processing apparatus according to the present invention thus prints a consent agreement for electronically processing check payment transaction on the back side of the check so that the processed check is also used for the consent agreement. The customer therefore does not need to keep track of two documents, that is, the check and consent agreement, for each individual transaction, and it is therefore much easier to manage the checks and consent agreement copies. The store also does not need to supply paper for printing the consent agreement, thus reducing paper consumption and improving efficiency.

Furthermore, the check is automatically detected to have been inserted in the correct orientation needed to print the consent agreement (that is, with the back side of the check facing up in this embodiment of the invention) when magnetic ink characters cannot be read from the check by the MICR reader 42, and only in this case is the consent agreement printed. It is therefore possible to prevent printing the consent agreement to the front side of the check when the check is accidentally inserted backwards.

Furthermore, the check is received back from the customer after the consent agreement is signed and the back side of the check, that is, the side containing the signed consent agreement, is then scanned and the image data captured. The store therefore does not need to retain a paper copy of the consent agreement, thus making it easier for the store to manage the consent agreements.

Yet further, by electronically storing images of both the check front items and signed consent agreement, and electronically processing the check payment transaction, the store can realize the benefits of a completely paperless transaction.

When scanning the consent agreement side of the check, the check is automatically detected to have been inserted in the correct orientation, that is, with the back side of the check facing up, if the MICR reader 42 is unable to read magnetic ink characters from the check, and the check is scanned only when the check is thus correctly inserted. It is therefore possible to prevent accidentally capturing image data from the front side of the check where the consent agreement is not printed if the check is inserted face up.

Furthermore, if necessary information will not be lost when the image data from the front side and back side (consent agreement) of the check is binarized, the size of each image file can be reduced by binarizing the image data. If this necessary information will be lost by binarization, the gray scale image data captured by scanning is stored. The recorded image data can therefore be used as reliable proof of the purchase and payment, and as proof of the customer's consent to electronic payment processing.

This embodiment of the invention is described with the check printing unit 44 disposed to print to the side of the check that is facing up when the check is inserted to the insertion opening 14, and the check is therefore inserted face down to the insertion opening 14 so that the back side is facing up in order to print the consent agreement. If the check printing unit 44 is disposed to print to the side of the check facing down, however, it will also be obvious that the check must be inserted face up, that is, with the back side of the check facing down, in order to print the consent agreement.

The printer could also be configured so that the check is inserted vertically instead of horizontally. In this case the check printing unit 44 can be disposed to either side of the check as it is only necessary for the check to be inserted with the back side of the check facing the check printing unit 44 in order to print the consent agreement.

The check printing unit 44 could also be configured with two printing units arranged to print to opposite sides of the check. In this case it is possible to automatically detect which side the back side of the check is facing and drive the printing unit facing that same side to print the consent agreement. It will therefore be possible in this case to print the consent agreement regardless of whether the back side of the check is facing up or down (or front side or back side).

This embodiment also ejects the check after printing and scanning the front side of the check, and then prints the consent agreement to the back side by having the operator re-insert the check with the face down. It is also possible to provide the check processing unit 10 with a reversing mechanism for reversing the front side and back side of the check mechanically. In this case the reversing mechanism can automatically reverse the front side and back side of the check after processing the front side of the check is completed so that printing the consent agreement can proceed without interruption after the front side of the check is processed. If the check is inserted backwards, this reversing mechanism could also be driven to automatically correct the check orientation so that the correct side of the check (i.e., the back side when printing the consent agreement) can be correctly oriented and processed regardless of whether the check is inserted with the front side or back side facing up.

Furthermore, while the threshold value determination process run in step S214 in FIG. 6 is executed according to the routine shown in FIG. 9, FIG. 11, and FIG. 12, the invention shall not be so limited and other techniques can be used. The scanned gray scale image data can also be stored without binarization.

It is also possible to use a different method to determine the threshold value in the threshold value determination process applied to the back side of the check in step S140 in FIG. 4, and the scanned gray scale image data can also be stored without binarization.

These embodiments are also described with the check processing unit 10 running the various processes and steps according to commands from a host computer 28 with display and input operations handled on the host computer 28. The invention is not limited to an arrangement where the check processing unit 10 and host computer 28 are separate units; they could be integrated as a single system.

While the invention has been described in conjunction with several specific embodiments, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

What is claimed is:

1. A method for processing a check payment transaction, comprising:
determining whether or not to electronically process the check payment transaction; and
printing on a back side of a check an agreement for consenting to electronic processing of the check payment transaction if and when it is determined to electronically process the check payment transaction.

2. A check processing method as described in claim 1, further comprising:
reading account information pre-recorded on a front side of the check; and
confirming check validity with a payment organization based on the read account information;
wherein the consent agreement printing step is executed only when check validity is confirmed, and the consent agreement printing step is not executed and further processing is interrupted when check validity is not confirmed.

3. A check processing method as described in claim 2, further comprising capturing and storing at least image data containing the account information pre-recorded on the front side of the check.

4. A check processing method as described in claim 2, further comprising printing a payment amount on the front side of the check.

5. A check processing method as described in claim 1, further comprising detecting whether or not the check is positioned properly for printing the consent agreement on the back side of the check, wherein the consent agreement printing step is executed only when the check is detected to be positioned properly.

6. A check processing method as described in claim 5, wherein the detecting step includes detecting whether or not magnetic ink characters are pre-recorded on the check surface, wherein the detecting step detects whether or not the check is positioned properly based on the magnetic ink character detection result.

7. A check processing method as described in claim 5, further comprising ejecting the check if and when the check is detected as not being positioned properly.

8. A check processing method as described in claim 3, further comprising capturing and storing image data containing the printed consent agreement and signature thereto from the back side of the check.

9. A check processing method as described in claim 8, further comprising detecting whether or not the check is positioned properly for capturing from the back side of the check the image data containing the consent agreement and signature thereto, wherein image data containing the printed consent agreement and signature thereto is only captured when the check is detected as being positioned properly.

10. A check processing method as described in claim 9, further comprising ejecting the check if and when the check is detected as not being positioned properly.

11. An apparatus for processing a check payment transaction, comprising:
an input unit configured to determine whether or not to electronically process the check payment transaction; and
a printer configured to print on a back side of a check an agreement for consenting to electronic processing of the check payment transaction if and when the input unit determines to electronically process the check payment transaction.

12. A check processing apparatus as described in claim 11, further comprising:
a reading unit configured to read account information pre-recorded on a front side of the check; and
a confirmation unit configured to confirm check validity with a payment organization based on the read account information;
wherein the printing unit is configured to print the consent agreement only when check validity is confirmed.

13. A check processing apparatus as described in claim 12, further comprising:
a scanner configured to capture and store at least image data containing the account information pre-recorded on the front side of the check.

14. A check processing apparatus as described in claim 12, wherein the printer is configured to print a payment amount on the front side of the check.

15. A check processing apparatus as described in claim 11, further comprising:
a detection unit configured to detect whether or not the back side of the check is facing the printer;
wherein the printer is configured to print the consent agreement on the back side of the check only when the detection unit detects that the back side of the check is facing the printer.

16. A check processing apparatus as described in claim 15, wherein the detection unit includes a magnetic head configured to detect whether or not pre-recorded magnetic ink characters are present on the check surface, wherein the detection unit detects whether or not the back side of the check is facing the printer based on the magnetic ink character detection result.

17. A check processing apparatus as described in claim 15, further comprising:
a check transportation unit configured to transport the check, and to eject the check from the check processing apparatus if and when the detection unit determines that the back side of the check is not facing the printer.

18. A check processing apparatus as described in claim 13, wherein the scanner is configured to capture image data containing the printed consent agreement and signature thereto from the back side of the check.

19. A check processing apparatus as described in claim 18, further comprising:
a detection unit for detecting whether or not the back side of the check is facing the scanner;
wherein the scanner is configured to capture image data containing the printed consent agreement and signature thereto from the back side of the check only when the detection unit detects that the back side of the check is facing the scanner.

20. A check processing apparatus as described in claim 19, further comprising:
a check transportation unit configured to transport the check, and to eject the check from the check processing apparatus if and when the detection unit detects that the back side of the check is not facing the scanner.

21. A check processing apparatus in communication with a host device for processing a check payment transaction according to commands received from the host, the check processing apparatus comprising:
an MICR reading unit configured to read magnetic ink characters pre-recorded on a front side of a check;
a printer configured to print on the check;
a transportation unit configured to convey the check through the check processing apparatus; and
a control unit configured to control the MICR reading unit, printing unit, and transportation unit;
wherein the control unit is configured to control the MICR reading unit to detect whether or not magnetic ink characters are pre-recorded on the check surface if and when a command is received from the host to print on the back side of the check, and to control the printer to print on the back side of the check based on the detection result of the MICR reading unit.

22. A check processing apparatus as described in claim 21, further comprising:
a scanner configured to capture an image of the check;
wherein the control unit is configured to control the MICR reading unit to detect whether or not magnetic ink characters are pre-recorded on the check surface only when a command is received from the host to capture image data from the back side of the check, and to control the scanner to scan and capture the image data based on the detection result of the MICR reading unit.

23. A check processing apparatus as described in claim 21, wherein the control unit is configured to control the transportation unit to eject the check from the check processing apparatus based on the detection result of the MICR reading unit.

24. A computer-readable medium containing a program for executing a check payment transaction process, the program comprising:
instructions for determining whether or not to electronically process the check payment transaction; and
instructions for issuing a command to print on a back side of a check an agreement for consenting to electronic processing of the check payment transaction if and when it is determined to electronically process the check payment transaction.

25. A computer-readable medium as described in claim 24, further comprising:
instructions for issuing a command for reading account information pre-recorded on a front side of the check;
instructions for obtaining the account information from the check;
instructions for confirming check validity with a payment organization based on the read account information; and
instructions for issuing a command to print the consent agreement only when check validity is confirmed.

26. A computer-readable medium as described in claim 24, further comprising:
instructions for issuing a command for capturing an image of a front side of the check; and
instructions for storing the image data captured from the front side of the check.

27. A computer-readable medium as described in claim 24, further comprising:
instructions for issuing a command for printing a payment amount on a front side of the check.

28. A computer-readable medium as described in claim 26, further comprising:
instructions for issuing a command for capturing an image of the back side of the check after the consent agreement is printed thereto; and
instructions for executing for storing the image data captured from the back side of the check.
